(19) United States
(12) Patent Application Publication
(10) Pub. No.: US 2022/0355670 A1
(43) Pub. Date: Nov. 10, 2022

(54) DEVICE AND METHOD FOR MANAGING BATTERY OF VEHICLE

(71) Applicants: HYUNDAI MOTOR COMPANY, Seoul (KR); Kia Corporation, Seoul (KR)

(72) Inventors: Hee Gun YANG, Anyang-si (KR); Jong Joo KIM, Suwon-si (KR)

(73) Assignees: HYUNDAI MOTOR COMPANY, Seoul (KR); Kia Corporation, Seoul (KR)

(21) Appl. No.: 17/500,303

(22) Filed: Oct. 13, 2021

(30) Foreign Application Priority Data
May 10, 2021 (KR) 10-2021-0060245

(51) Int. Cl. B60L 3/04

(52) U.S. Cl. CPC B60L 3/04

(57) ABSTRACT

A device and a method for managing a battery of a vehicle, may include a first battery configured for supplying main power to the vehicle, a second battery configured for supplying auxiliary power to the vehicle, a receiver configured for receiving a bonnet open signal of the vehicle, and a controller that cuts off power from the second battery in a response to the bonnet open signal, improving a maintenance efficiency of a vehicle to which a dual power system is applied.

### CROSS-REFERENCE TO RELATED APPLICATION

The present application claims priority to Korean Patent Application No. 10-2021-0060245, filed on May 10, 2021, the entire contents of which is incorporated herein for all purposes by this reference.

### BACKGROUND OF THE INVENTION

### Field of the Invention

The present invention relates to a technology for efficiently cutting off power of a battery supplied to a load of a vehicle in a process of maintaining the vehicle to which a dual power system is applied.

### Description of Related art

In general, an electronic device for a vehicle such as a drive video record system (DVRS), a navigation device, an audio device, a lighting device, and the like mounted on the vehicle is operated by receiving power from a battery (e.g., a lead-acid storage battery) for the vehicle. In particular, because the DVRS has to film a video of a region around the vehicle even while parking, the DVRS must be continuously supplied with the power from the battery for the vehicle.

Because such battery for the vehicle has a limited capacity of about 60 AH to 100 AH, when the DVRS is operating in a state in which an alternator is not operating (a state in which the battery for the vehicle is not charged) because an engine of the vehicle is not running, a case in which start of the vehicle is impossible as discharge of the battery for the vehicle is caused often occurs.

Thus, recently, a dual power system that has the lead-acid storage battery and a lithium ion battery as the battery for the vehicle to stably supply power to an electronic device for the vehicle is being applied to the vehicle. Such dual power system of the vehicle has advantages of not only stably supplying the power to the DVRS, but also, facilitating stable start of the vehicle.

However, during maintenance of the vehicle to which such dual power system is applied, the power of the batteries supplied to the electronic device for the vehicle may be cut off to prevent an electric shock accident of a mechanic and a breakdown of the electronic device for the vehicle. Power of the lead-acid storage battery located in an engine compartment or a trunk of the vehicle is configured to be cut off relatively easily, but power of the lithium ion battery is not able to be easily cut off because the lithium ion battery is located below a passenger seat or below a rear seat of the vehicle.

A conventional method for shutting off the power of the dual power system includes removing a wire connected to a terminal of the lead-acid storage battery after opening an engine compartment cover (a bonnet) or a trunk cover of the vehicle, and then, removing a connector connected to the lithium ion battery after removing the passenger seat or the rear seat of the vehicle. Therefore, there is a problem in that a maintenance efficiency of the vehicle is low.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a device and a method for managing a battery of a vehicle which may improve a maintenance efficiency of the vehicle to which a dual power system is applied by cutting off power from a lithium ion battery in a response to an engine compartment bonnet open signal or a trunk bonnet open signal in an engine stop state of the vehicle provided with a lead-acid storage battery and the lithium ion battery.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, a device configured for managing a battery of a vehicle includes a first battery configured for supplying main power to the vehicle, a second battery configured for supplying auxiliary power to the vehicle, a receiver configured for receiving a bonnet open signal of the vehicle, and a controller that cuts off power from the second battery in a response to the bonnet open signal.

In various exemplary embodiments of the present invention, the controller may cut off the power from the second battery when the controller receives the bonnet open signal while an engine of the vehicle is stopped.

In various exemplary embodiments of the present invention, the controller may cut off the power from the second battery when the controller receives an engine compartment bonnet open signal through the receiver.

In various exemplary embodiments of the present invention, the controller may cut off the power from the second battery when the controller receives an engine compartment bonnet open signal of the vehicle through the receiver while an engine of the vehicle is stopped.

In various exemplary embodiments of the present invention, the controller may cut off the power from the second battery when the controller receives a trunk bonnet open signal of the vehicle through the receiver.

In various exemplary embodiments of the present invention, the controller may cut off the power from the second battery when the controller receives a trunk bonnet open signal of the vehicle through the receiver while an engine of the vehicle is stopped.

In various exemplary embodiments of the present invention, the device may further include a relay connected to the second battery and configured for cutting off the power from the second battery according to a control signal of the controller.

In various exemplary embodiments of the present invention, the controller may be configured to control the relay to cut off the power from the second battery when the controller receives the bonnet open signal through the receiver.

In various exemplary embodiments of the present invention, the first battery may be a lead-acid storage battery.

In various exemplary embodiments of the present invention, the second battery may be a lithium ion battery.

According to various aspects of the present invention, a method for managing a battery of a vehicle includes receiving, by a receiver, a bonnet open signal of a vehicle provided with a lead-acid storage battery and a lithium ion battery, and cutting off, by a controller, power from the lithium ion battery in a response to the bonnet open signal.

In various exemplary embodiments of the present invention, the cutting off of the power from the lithium ion battery may include cutting off the power from the lithium ion battery when the controller receives the bonnet open signal while an engine of the vehicle is stopped.

In various exemplary embodiments of the present invention, the cutting off of the power from the lithium ion battery may include cutting off the power from the lithium ion battery when the controller receives an engine compartment bonnet open signal through the receiver.

In various exemplary embodiments of the present invention, the cutting off of the power from the lithium ion battery may include cutting off the power from the lithium ion battery when the controller receives an engine compartment bonnet open signal of the vehicle through the receiver while an engine of the vehicle is stopped.

In various exemplary embodiments of the present invention, the cutting off of the power from the lithium ion battery may include cutting off the power from the lithium ion battery when the controller receives a trunk bonnet open signal of the vehicle through the receiver.

In various exemplary embodiments of the present invention, the cutting off of the power from the lithium ion battery may include cutting off the power from the lithium ion battery when the controller receives a trunk bonnet open signal of the vehicle through the receiver while an engine of the vehicle is stopped.

In various exemplary embodiments of the present invention, the cutting off of the power from the lithium ion battery may include controlling, by the controller, a relay to cut off the power from the lithium ion battery when the controller receives the bonnet open signal through the receiver.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an exemplary view of a vehicle to which a device configured for managing a battery of a vehicle according to various exemplary embodiments of the present invention is applied;

FIG. 2 is a block diagram of a device configured for managing a battery of a vehicle according to various exemplary embodiments of the present invention;

FIG. 3 is a flowchart of a method for managing a battery of a vehicle according to various exemplary embodiments of the present invention; and

FIG. 4 is a block diagram showing a computing system for executing a method for managing a battery of a vehicle according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of the related known configuration or function will be omitted when it is determined that it interferes with the understanding of the exemplary embodiment of the present invention.

In describing the components of the exemplary embodiment according to various exemplary embodiments of the present invention, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning which is consistent with their meaning in the context of the relevant art and will not be interpreted in an idealized or overly formal sense unless expressly so defined herein.

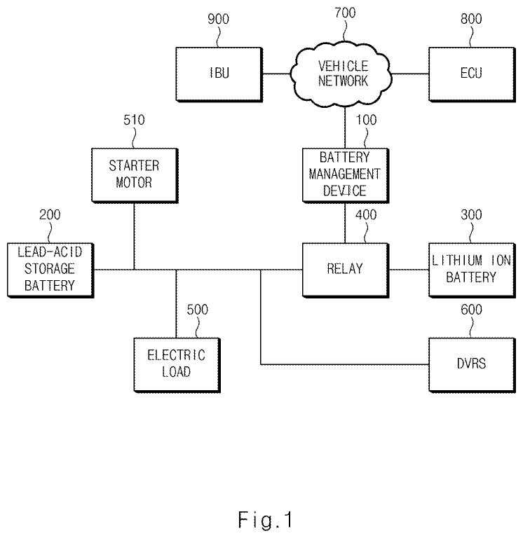

FIG. 1 is an exemplary view of a vehicle to which a device configured for managing a battery of a vehicle according to various exemplary embodiments of the present invention is applied.

As shown in FIG. 1, a vehicle to which a battery management device of the vehicle according to various exemplary embodiments of the present invention is applied may include a battery management device 100, a lead-acid storage battery 200, a lithium ion battery 300, a relay 400, an electric load 500, a starter motor 510, a drive video record system (DVRS) 600, a vehicle network 700, an engine control unit (ECU) 800, and an integrated body control unit (IBU) 900.

Each of the components will be described. First, the battery management device 100 of the vehicle according to various exemplary embodiments of the present invention may cut off power from the lithium ion battery 300 based on an engine compartment bonnet open signal or a trunk bonnet open signal in an engine stop state of the vehicle, improving a maintenance efficiency of a vehicle to which a dual power system is applied. Such battery management device 100 may be implemented as a separate module, or may be located inside a housing of the lithium ion battery 300.

The lead-acid storage battery 200, which is a battery that supplies main power to the vehicle, may be used by being recharged even when being completely discharged, and may not only supply power to the electric load 500, but also supply power to the starter motor 510 of an engine.

The lithium ion battery 300, which is a battery that supplies auxiliary power to the vehicle, may supply constant power to the DVRS 600. Furthermore, the lithium ion battery 300 is connected in parallel with the lead-acid storage battery 200 to supply power to the starter motor 510 of the engine as well as to the electric load 500. A system that supplies power to the electric load 500, the starter motor 510, and the DVRS 600 provided in the vehicle using the lead-acid storage battery 200 and the lithium ion battery 300 as such is referred to as the dual power system.

The relay 400, which is a kind of switch which is configured to cut off the power from the lithium ion battery 300, may operate under control of the battery management device 100. Such relay 400 may be located inside the housing of the lithium ion battery 300.

The electric load 500 may include all electronic devices provided in the vehicle and operated by the power of the lead-acid storage battery 200 and the power of the lithium ion battery 300. As an example, the electric load 500 may include various safety devices, power trains, convenience devices, infotainment devices, and the like.

The DVRS 600 may include, for example, a built-in drive video recording device (a built-in cam) mounted on the rear of a rear view mirror of the vehicle.

The vehicle network 700 may include a controller area network (CAN), a controller area network with flexible data-rate (CAN FD), a local interconnect network (LIN), a FlexRay, a media oriented systems transport (MOST), an Ethernet, and the like.

The engine control unit (ECU) 800, which is a control device that performs overall control in relation to an operation of the engine provided in the vehicle, may detect a state (run, stop, and the like) of the engine.

The IBU 900, which is an electronic control unit (ECU) that integrates a body control module (BCM), a smartkey system, and a tire pressure monitoring system (TPMS), may communicate with individual ECUs that, respectively control a wiper, a headlamp, a power seat, an engine compartment bonnet, a trunk bonnet, a door, and the like to control vehicle body electronics integrally. Such IBU 900 may mainly communicate with electronic control units (ECUs) connected to a body CAN (BCAN), and may also communicate with electronic control units (ECUs) connected to a chassis CAN (CCAN) and a powertrain CAN (PCAN).

In the present connection, the BCM may perform a convenience function and a safety function alone, or may perform a control function in association with another electronic control unit (ECU). In the present connection, the convenient function may include a rear curtain control function, a vehicle lock control function, an external lamp control function, a wiper/washer control function, and the like, the safety function may include a vehicle alert state control function, a mobile telematics system (MTS)-related alarm control function, a front and rear parking assistance control function, a function for controlling a warning based on a seat belt or door opening, and the like, and the control function may include a function for controlling a location of a seat, a function for controlling opening/closing of a tailgate, a function for controlling opening/closing of the engine compartment bonnet, and the like.

The smart key system is a system that operates by LF/RF communication between an antenna provided in the vehicle and an antenna provided in a smart key. Such smart key system recognizes the smart key, allowing a user to lock/unlock the vehicle door by pressing a push button on a door handle, and to open or close the trunk bonnet by pressing an open/close button of the trunk bonnet, and generating a warning based on a location of the smart key. Furthermore, the smart key system allows the user to start the vehicle by pressing a start button located next to a steering wheel when the smart key is inside the vehicle.

The TPMS is a system that has a tire pressure sensor (TPS) on each wheel of the vehicle, and periodically monitors an air pressure detected through the TPS.

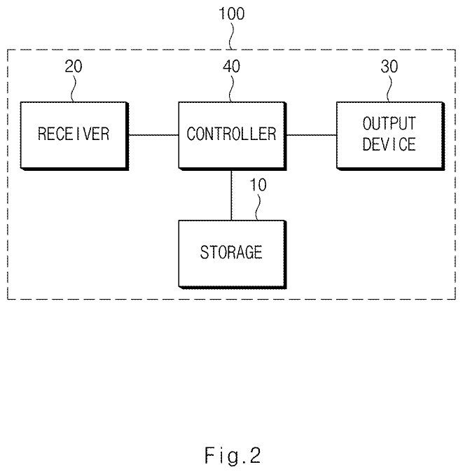

FIG. 2 is a block diagram of a device configured for managing a battery of a vehicle according to various exemplary embodiments of the present invention.

As shown in FIG. 2, the battery management device 100 of the vehicle according to various exemplary embodiments of the present invention may include storage 10, a receiver 20, an output device 30, and a controller 40. In the present connection, depending on a scheme of implementing the battery management device 100 of the vehicle according to various exemplary embodiments of the present invention, the components may be combined with each other to be implemented as one component, or some components may be omitted.

Each of the components will be described. First, the storage 10 may store various logics, algorithms, and programs required in a process of detecting the engine stop of the vehicle provided with the lead-acid storage battery 200 and the lithium ion battery 300, receiving the engine compartment bonnet open signal or the trunk bonnet open signal from the vehicle, and cutting off the power from the lithium ion battery 300 based on the received engine compartment bonnet open signal or trunk bonnet open signal.

Such storage 10 may include at least one type of recording media (storage media) of a memory of a flash memory type, a hard disk type, a micro type, a card type (e.g., a secure digital card (SD card) or an eXtream digital card (XD card)), and the like, and/or a memory of a random access memory (RAM), a static RAM (SRAM), a read-only memory (ROM), a programmable ROM (PROM), an electrically erasable PROM (EEPROM), a magnetic RAM (MRAM), a magnetic disk, and an optical disk type.

The receiver 20, which is a module that provides an interface for accessing the vehicle network 700, may receive, through the vehicle network, state information (e.g., the start, the stop, and the like) of the engine, the engine compartment bonnet open signal, and the trunk bonnet open signal.

The receiver 20 may include at least one of a mobile communication module, a wireless Internet module, and/or a short-range communication module as a communication module.

The mobile communication module may receive various information through a mobile communication network built based on technical standards or communication schemes for mobile communication (e.g., a global system for mobile communication (GSM), a code division multi access (CDMA), a code division multi access 2000 (CDMA2000), an enhanced voice-data optimized or enhanced voice-data only (EV-DO), a wideband CDMA (WCDMA), a high speed downlink packet access (HSDPA), a high speed uplink packet access (HSUPA), a long term evolution (LTE), a long term evolution-advanced (LTEA), and the like), a 4th generation mobile telecommunication (4G), and a 5th generation mobile telecommunication (5G).

The wireless Internet module, which is a module for wireless Internet access, may receive the various information through a wireless LAN (WLAN), a wireless-fidelity (Wi-Fi), a wireless fidelity (Wi-Fi) Direct, a digital living network alliance (DLNA), a wireless broadband (WiBro), a Worldwide Interoperability for Microwave Access (WiMAX), a high speed downlink packet access (HSDPA), a high speed uplink packet access (HSUPA), a long term evolution (LTE), a long term evolution-advanced (LTE-A), and the like.

The short-range communication module may support short-range communication using at least one of technologies of a Bluetooth™, a radio frequency identification (RFID), an infrared data association (IrDA), an ultra wideband (UWB), a ZigBee, a near field communication (NFC), and/or a wireless universal serial bus (Wireless USB).

The output device 30 may output a visual notification or an audible notification indicating that the power from the lithium ion battery 300 is cut off when the engine compartment bonnet is opened or the trunk bonnet is opened while the engine of the vehicle is stopped.

The controller 40 may perform overall control such that each of the components may perform a function thereof normally. Such controller 40 may be implemented in a form of hardware, may be implemented in a form of software, or may be implemented in a form of a combination of the hardware and the software. The controller 40 may be implemented as a microprocessor, but may not be limited thereto.

The controller 40 may perform various control required in a process of detecting the engine stop of the vehicle provided with the lead-acid storage battery 200 and the lithium ion battery 300, receiving the engine compartment bonnet open signal or the trunk bonnet open signal from the vehicle, and cutting off the power from the lithium ion battery 300 based on the received engine compartment bonnet open signal or trunk bonnet open signal.

The controller 40 may control the receiver 20 to receive the vehicle's engine state information (engine stop information) from the vehicle network 700.

The controller 40 may control the receiver 20 to receive the vehicle's engine compartment bonnet open signal from the vehicle network 700.

The controller 40 may control the receiver 20 to receive the vehicle's trunk bonnet open signal from the vehicle network 700.

The controller 40 may control the relay 400 to cut off the power from the lithium ion battery 300 when the engine compartment bonnet open signal or the trunk bonnet open signal is received through the receiver 20. In the present connection, a mechanic opens the engine compartment bonnet or the trunk bonnet of the vehicle. In the present process, the power of the lithium ion battery 300 is cut off by the controller 40. Only by removing a wire connected to a terminal of the lead-acid storage battery 200, not only the power of the lead-acid storage battery 200 provided in the vehicle, but also, the power of the lithium ion battery 300 may be cut off.

The controller 40 controls the relay 400 to cut off the power from the lithium ion battery 300 when the engine compartment bonnet open signal or the trunk bonnet open signal is received while the engine of the vehicle is stopped. However, when the engine compartment bonnet open signal or the trunk bonnet open signal is received even when the engine of the vehicle is running, the controller 40 may control the relay 400 to cut off power from the lithium ion battery 300.

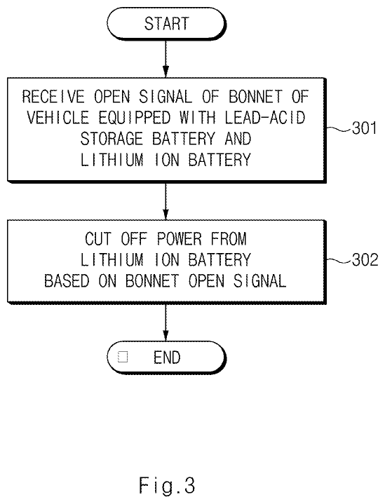

FIG. 3 is a flowchart of a method for managing a battery of a vehicle according to various exemplary embodiments of the present invention.

First, the receiver 20 receives the open signal of the bonnet of the vehicle provided with the lead-acid storage battery 200 and the lithium ion battery 300 (301).

Thereafter, the controller 40 cuts off the power from the lithium ion battery 300 based on the bonnet open signal (302).

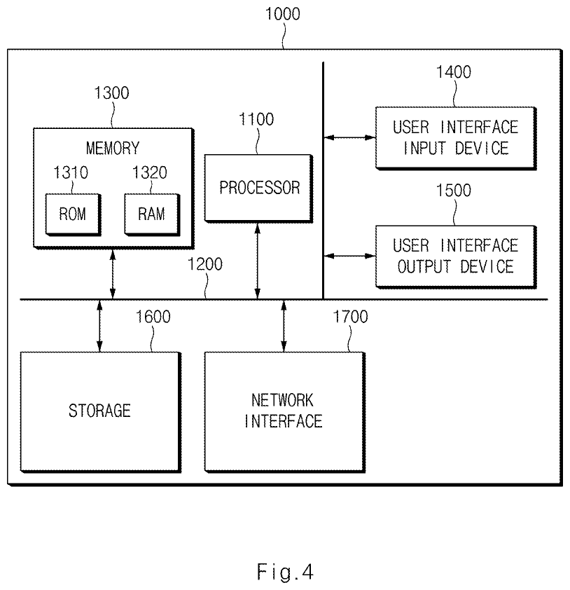

FIG. 4 is a block diagram showing a computing system for executing a method for managing a battery of a vehicle according to various exemplary embodiments of the present invention.

Referring to FIG. 4, the method for managing the battery of the vehicle according to various exemplary embodiments of the present invention described above may also be implemented through a computing system. A computing system 1000 may include at least one processor 1100, a memory 1300, a user interface input device 1400, a user interface output device 1500, storage 1600, and a network interface 1700 connected via a system bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present invention, and various modifications and changes may be made by those skilled in the art without departing from the essential characteristics of the present invention.

Therefore, the exemplary embodiments included in various exemplary embodiments of the present invention are not intended to limit the technical idea of the present invention but to illustrate the present invention, and the scope of the technical idea of the present invention is not limited by the embodiments. The scope of the present invention should be construed as being covered by the scope of the appended claims, and all technical ideas falling within the scope of the claims should be construed as being included in the scope of the present invention.

The device and the method for managing the battery of the vehicle according to various exemplary embodiments of the present invention as described above may improve the maintenance efficiency of the vehicle to which the dual power system is applied by cutting off the power from the lithium ion battery in a response to the engine compartment bonnet open signal or the trunk bonnet open signal in the engine stop state of the vehicle provided with the lead-acid storage battery and the lithium ion battery.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A device for managing a battery of a vehicle, the device comprising:
a first battery configured for supplying main power to the vehicle;
a second battery configured for supplying auxiliary power to the vehicle;
a receiver configured for receiving a bonnet open signal of the vehicle; and
a controller electrically connected to the receiver to receive the bonnet open signal through the receiver and configured to cut off power from the second battery when the controller receives the bonnet open signal.

2. The device of claim 1, wherein the controller is configured to cut off the power from the second battery when the controller receives the bonnet open signal while an engine of the vehicle is stopped.

3. The device of claim 1,
wherein the bonnet open signal includes an engine compartment bonnet open signal, and
wherein the controller is configured to cut off the power from the second battery when the controller receives the engine compartment bonnet open signal through the receiver.

4. The device of claim 1,
wherein the bonnet open signal includes an engine compartment bonnet open signal of the vehicle, and
wherein the controller is configured to cut off the power from the second battery when the controller receives the engine compartment bonnet open signal of the vehicle through the receiver while an engine of the vehicle is stopped.

5. The device of claim 1,
wherein the bonnet open signal includes a trunk bonnet open signal of the vehicle and
wherein the controller is configured to cut off the power from the second battery when the controller receives the trunk bonnet open signal of the vehicle through the receiver.

6. The device of claim 1,
wherein the bonnet open signal includes a trunk bonnet open signal of the vehicle and
wherein the controller is configured to cut off the power from the second battery when the controller receives the trunk bonnet open signal of the vehicle through the receiver while an engine of the vehicle is stopped.

7. The device of claim 1, further including:
a relay connected to the second battery and configured for cutting off the power from the second battery according to a control signal of the controller.

8. The device of claim 7, wherein the controller is configured to control the relay to cut off the power from the second battery when the controller receives the bonnet open signal through the receiver.

9. The device of claim 8,
wherein the bonnet open signal includes a trunk bonnet open signal and an engine compartment bonnet open signal of the vehicle, and
wherein the controller is configured to control the relay to cut off the power from the second battery when the controller receives the trunk bonnet open signal or the engine compartment bonnet open signal of the vehicle through the receiver.

10. The device of claim 1, wherein the first battery is a lead-acid storage battery.

11. The device of claim 1, wherein the second battery is a lithium ion battery.

12. A method for managing a battery of a vehicle, the method comprising:
receiving, by a receiver, a bonnet open signal of the vehicle provided with a lead-acid storage battery and a lithium ion battery; and
cutting off, by a controller electrically connected to the receiver, power from the lithium ion battery when the controller receives the bonnet open signal through the receiver.

13. The method of claim 12, wherein the cutting off of the power from the lithium ion battery includes:
cutting off the power from the lithium ion battery when the controller receives the bonnet open signal while an engine of the vehicle is stopped.

14. The method of claim 12,
wherein the bonnet open signal includes an engine compartment bonnet open signal of the vehicle, and
wherein the cutting off of the power from the lithium ion battery includes:
cutting off the power from the lithium ion battery when the controller receives the engine compartment bonnet open signal through the receiver.

15. The method of claim 12,
wherein the bonnet open signal includes an engine compartment bonnet open signal of the vehicle, and
wherein the cutting off of the power from the lithium ion battery includes:
cutting off the power from the lithium ion battery when the controller receives the engine compartment bonnet open signal of the vehicle through the receiver while an engine of the vehicle is stopped.

16. The method of claim 12,
wherein the bonnet open signal includes a trunk bonnet open signal, and
wherein the cutting off of the power from the lithium ion battery includes:
cutting off the power from the lithium ion battery when the controller receives the trunk bonnet open signal of the vehicle through the receiver.

17. The method of claim 12,
wherein the bonnet open signal includes a trunk bonnet open signal, and
wherein the cutting off of the power from the lithium ion battery includes:
cutting off the power from the lithium ion battery when the controller receives the trunk bonnet open signal of the vehicle through the receiver while an engine of the vehicle is stopped.

18. The method of claim 12, wherein the cutting off of the power from the lithium ion battery includes:
controlling, by the controller, a relay connected to the lithium ion battery to cut off the power from the lithium ion battery when the controller receives the bonnet open signal through the receiver.

19. The method of claim 18,
wherein the bonnet open signal includes a trunk bonnet open signal and an engine compartment bonnet open signal of the vehicle, and
wherein the controller is configured to control the relay to cut off the power from the second battery when the controller receives the trunk bonnet open signal or the engine compartment bonnet open signal of the vehicle through the receiver.

20. A non-transitory computer readable storage medium on which a program for performing the method of claim 12 is recorded.
